(19) United States
(12) Patent Application Publication
(10) Pub. No.: US 2005/0021582 A1
(43) Pub. Date: Jan. 27, 2005

(54) Method and system for computing the mass properties of polygons and polyhedra

(75) Inventor: Michael Kallay, Bellevue, WA (US)

Correspondence Address: Albert S. Michalik;Law Offices of Albert S. Michalik, PLLC, 704 - 228th Avenue NE, Suite 193, Sammamish, WA, 98074, US

(73) Assignee: MICROSOFT CORPORATION, REDMOND, WA (US)

(21) Appl. No.: 10/626,802

(22) Filed: Jul. 23, 2003

(51) Int. Cl. G06F 7/38

(52) U.S. Cl. 708/446

(57) ABSTRACT

A method and system providing formulae that express integrals of quadratic homogeneous polynomials on polygons and polyhedra, such as entries of the moment of inertia tensor, in terms of vertex coordinates. The formulae for a triangle provide the mass properties without integration, and can be combined (using a signed sum) to determine the mass properties for any polygon. Likewise, the concept extends to a polyhedron, which may be built from a plurality of signed pyramids. An algorithm combines the formulae to determine the mass properties of a polyhedron. The formulae and algorithm may be used in a graphics processing environment.

### FIELD OF THE INVENTION

The invention relates generally to computer systems, and more particularly to computer graphics.

### BACKGROUND OF THE INVENTION

The center of mass and the moment of inertia tensor are known as the mass properties of a rigid body. Engineers use mass properties them to analyze the strength of mechanical structures, and to compute the dynamics of moving bodies. Similarly, mass properties can be used in computer simulations. As physics-based simulation is becoming important in movies and computer games, the mass properties are gaining importance in both two-dimensional and three-dimensional computer graphics. For example, to realistically simulate the motion of a moving body following a collision, the mass properties may be used to determine where the object should appear in subsequent frames, e.g., the moment of inertia of a body is a primary factor in determining the speed of the rotation of the body following a collision.

While computing the center of mass is straightforward, computing the moment of inertia is much more elaborate. Standard mathematical references contain formulae for some special shapes (e.g. rectangles, cylinders) in terms of their dimensions. For polyhedrons in general, an algorithm for computing the integrals on a polyhedron has been presented in the reference by Brian Mirtich, Fast and Accurate Computation of Polyhedral Mass Properties, Journal of Graphics Tools, volume 1, number 2, 1996 (the Mirtich reference). This algorithm relies on a scheme proposed in Sheung-ling Lien and James T. Kajiya, A symbolic method for calculating the integral properties of arbitrary nonconvex polyhedra, IEEE Computer Graphics and Applications, 4(10), pp 35-41, 1984, which describes converting a volume integral on a polyhedron to a sum of surface integrals on its facets, using the Divergence theorem. That scheme is used in the aforementioned Mirtich reference, to convert the resulting facets integrals to line integrals on their edges, using Green's theorem.

As the images rendered by computer graphics become more realistic, significant numbers of computations at high frame rates are required, however large numbers of overly complex calculations (e.g., on hundreds or even thousands of polygons) may not be able to be performed fast enough on commercially available computing devices such as gaming devices. Further, reducing the complexity so that developers can better use quadratic homogeneous polynomials (such as the entries of the moment of inertia tensor) is also desirable. What is needed is a more straightforward way to compute the mass properties of polygons and polyhedra.

### SUMMARY OF THE INVENTION

Briefly, the present invention provides a method and system in which formulae express integrals on polygons and polyhedra in terms of vertex coordinates. As a result, the moment of inertia of a polygon can be computed without integrating, e.g., for a triangle by using multiplication of one-twelfth the area times the sum of the dot products of (or based on) the vertices.

In one implementation, the entries of the moment of inertia tensor and the moment of inertia of a body about a given axis through the origin are volume integrals of homogeneous quadratic polynomials.

If T is a triangle with vertices P₁,P₂,P₃ then the following two formulae apply:

$$\begin{matrix}\int {\int }_{T} f ( X - C ) = \frac{a ( T )}{18} {\sum }_{i = 1}^{3} ( f ( {P}_{i} ) - g ( {P}_{i - 1} , {P}_{i} ) ) \\ and & ( 3 ) \\ {\int \int }_{T} f ( X - C ) = \frac{a ( T )}{12} {\sum }_{i = 1}^{3} f ( {P}_{i} - C ) , & ( 4 )\end{matrix}$$

where ƒ(X) is any homogeneous quadratic function of the coordinates, g(X₁,X₂) is its polar form, a(T) is the area of T, and C is the centroid of T. Given these formulae, it is seen that the moment of inertia (or like quadratic homogeneous polynomials) can be determined without integration. For example, with a triangle of vertices P₁,P₂,P₃ with an origin at its centroid, the moment of inertia is

$$\frac{area}{12} ( {P}_{1} \cdot {P}_{2} + {P}_{2} \cdot {P}_{3} + {P}_{3} \cdot {P}_{1} ) .$$

Thus, simple multiplication and division (applied to the sums of the dot products of the vertices) provides the solution.

Moreover, as is known, particularly in computer graphics technology, any polygon may be divided into a sum of triangles. Thus, the above present invention may be applied to any polygon, including one with holes. A simple triangulation process may establish the triangles as is known in the art. However, if B is non-convex or does not contain the origin, then some of these triangles may overlap, while some may spill out of B. Nevertheless, equality is preserved through the use of a signed sum of the triangles, where the sign is determined by the orientation (clockwise or counterclockwise) of the path O,Pᵢ₋₁,P₁. Any overlapping and/or spilling out is handled in a straightforward way by replacing the area of each triangle with one-half of the determinant relative to an origin,

$$\frac{1}{2} det ( {P}_{i - 1} , {P}_{i} ) ,$$

which inherently handles the proper sign. Taking the sum of the signed triangles that make up any polygon provides the solution. As a result, integration can be avoided regardless of the shape of the polygon.

Various aspects of the present invention may be applied to three dimensional polyhedra via integrating over a cone. A general polyhedron is a “signed union” of cones extended from an origin to its facets, where the sign is determined by the side of the plane of the facet that contains the origin, positive if the origin lies on the interior side. When the body is a simplicial polyhedron, i.e., when all its facets are triangles, which is common in computer graphics, if every facet Fᵢ of a body B is a triangle with vertices P_{i,1},P_{i,2},P_{i,3}, and ƒ is a homogeneous quadratic polynomial then:

$$\int {\int }_{B} \int f ( X ) ⅆ v = \frac{1}{6} {\sum }_{i = 1}^{n} det ( {P}_{i , 1} , {P}_{i , 2} , {P}_{i , 3} ) {\sum }_{j = 1}^{3} ( f ( {P}_{i , j} ) + g ( {P}_{i , j - 1} , {P}_{i , j} ) ) . \qquad ( 10 )$$

where g is the polar form of ƒ.

Thus, a general polyhedron may be made up of the signed sum of the cones/pyramids. Thus, for a general polyhedron, in which the body B is a polyhedron with facets F₁,Fₙ, and ƒ is a homogeneous quadratic polynomial whose polar form is g then

$$\int {\int }_{B} \int f ( X ) ⅆ v = - \frac{1}{5} {\sum }_{i = 1}^{n} ( {N}_{i} \cdot {C}_{i} ) a ( {F}_{i} ) ( f ( {C}_{i} ) + \frac{1}{12} {\sum }_{j = 1}^{n} det ( \overline{{P}_{i , j - 1}} , \overline{{P}_{i , j}} , {N}_{i} ) ( f ( \overline{{P}_{i , j - 1}} ) + f ( \overline{{P}_{i , j}} ) + g ( \overline{{P}_{i , j - 1}} , \overline{{P}_{i , j}} ) ) )$$

where Cᵢ is the centroid and a(Fᵢ) is the area of Fᵢ, and \overline{P_{i,j}} denotes P_{i,j}−Cᵢ.

Note that the centroid and area of Fᵢ can be obtained from:

$$\begin{matrix}a ( {F}_{i} ) = \frac{1}{2} {\sum }_{j = 3}^{m ( i )} det ( {P}_{i , j - 1} - {P}_{i , 1} , {P}_{i , j} - {P}_{i , 1} , {N}_{i} ) & ( 12 ) \\ {C}_{i} = \frac{1}{6 a ( {F}_{i} )} {\sum }_{j = 3}^{m ( i )} det ( {P}_{i , j - 1} - {P}_{i , 1} , {P}_{i , j} - {P}_{i , 1} {N}_{i} ) ( {P}_{i , 1} + {P}_{i , j - 1} + {P}_{i , 1} ) & ( 13 )\end{matrix}$$

where Nᵢ is a unit vector normal the facet Fᵢ.

Any mass properties formula can now be generated by defining the appropriate function ƒ and multiplying by density. For example, with ƒ(X)=X·X, and its polar form g(X₁,X₂)=X₁·X₂ we have from formula (4) that the moment of inertia of a triangle with vertices P₁,P₂,P₃, mass m and centroid C, about an axis perpendicular to the plane of T at C is:

$$\frac{m}{12} {\sum }_{i = 1}^{3} ( {P}_{i} - C ) \cdot ( {P}_{i} - C ) , \\ or : \\ \frac{m}{18} {\sum }_{i = 1}^{3} ( {P}_{i} \cdot {P}_{i} - {P}_{i - 1} \cdot {P}_{i} ) .$$

In keeping with the present invention, it follows from formula (5) that the moment of inertia of a triangle with vertices P₁,P₂,P₃ and mass m about an axis (O,V) is:

$$\frac{1}{6} m {\sum }_{i = 1}^{3} ( ( {P}_{i} \times V ) \cdot ( {P}_{i} \times V ) + ( {P}_{i - 1} \times V ) \cdot ( {P}_{i} \times V ) ) .$$

The integrands for the entries of moment of inertia tensor are:
For Iₓₓ: ƒ(X)=y²+z² and the polar form is g(X₁,X₂)=y₁y₂+z₁z₂.
For I_{yy}: ƒ(X)=z²+x² and the polar form is g(X₁,X₂)=z₁z₂+x₁x₂.
For I_{zz}: ƒ(X)=x²+y² and the polar form is g(X₁,X₂)=x₁x₂+y₁y₂.

$$\begin{matrix}For {I}_{xy} : f ( X ) = - xy and the polar form is g ( {X}_{1} , {X}_{2} ) = - \frac{1}{2} ( {x}_{1} {y}_{2} + {y}_{1} {x}_{2} ) . \\ For {I}_{yz} : f ( X ) = - yz and the polar form is g ( {X}_{1} , {X}_{2} ) = - \frac{1}{2} ( {y}_{1} {z}_{2} + {z}_{1} {y}_{2} ) . \\ For {I}_{zx} : f ( X ) = - zx and the polar form is g ( {X}_{1} , {X}_{2} ) = - \frac{1}{2} ( {z}_{1} {x}_{2} + {x}_{1} {z}_{2} ) .\end{matrix}$$

The present invention can selectively combine the formulae to produce a desired result for any polyhedron. For example, after initializing the resulting integrals (which will be summed) to zero, for each facet with outward normal Nᵢ, if the facet is a triangle (P_{i,1},P_{i,2},P_{1,3}), the area of the triangle is computed from the vertices, using the above described formula a

$$( T ) = \frac{1}{2} \vert det ( {P}_{i , 2} - {P}_{i , 1} , {P}_{i , 3} - {P}_{i , 1} ) \vert ,$$

while centroid is computed as

$${C}_{i} = \frac{1}{3} ( {P}_{i , 1} + {P}_{i , 2} + {P}_{i , 3} ) .$$

With the centroid and area known, and applied to solve the formula

$${\int \int }_{T} f ( X - C ) = \frac{a ( T )}{12} {\sum }_{i = 1}^{3} f ( {P}_{i} - C ) ,$$

the appropriate facet integrals about centroid Cᵢ are easily computed.

If the facet is not a triangle, the centroid is computed as

$${C}_{i} = \frac{1}{6 a ( {F}_{i} )} {\sum }_{j = 3}^{m ( i )} det ( {P}_{i , j - 1} - {P}_{i , 1} , {P}_{i , j} - {P}_{i , 1} , {N}_{i} ) ( {P}_{i , 1} + {P}_{i , j - 1} + {P}_{i , 1} ) .$$

Then, the appropriate facet integrals about Cᵢ are computed using

$${\int \int }_{B} f ( X ) ⅆ a = \frac{1}{12} {\sum }_{i = 1}^{n} det ( {P}_{i - 1} , {P}_{i} ) ( f ( {P}_{i - 1} ) + f ( {P}_{i} ) + g ( {P}_{i - 1} , {P}_{i} ) ) .$$

With the integrals about the centroid of the facet Cᵢ, whether computed for a triangle or otherwise, the facet integrals about the origin are computed using

$${\int \int }_{B} f ( X ) ⅆ a = {\int \int }_{B} f ( X - C ) ⅆ a + a ( B ) f ( C ) .$$

The signed volume integrals over the facet's cone are computed using

$${\int \int \int }_{B} f ( X ) ⅆ v = \frac{1}{5} h ( F ) {\int \int }_{F} f ( X ) ⅆ a ,$$

with Nᵢ·Cᵢ for the signed height. The computed integrals are added to the accumulative resulting integrals, until no facets remain and the accumulative resulting integrals are known.

In one example implementation, the formulae may be incorporated in a graphics computation process. Because contemporary computer graphics use large quantities of triangles, thus the present invention can provide substantial benefits when the mass properties of an object or multiple objects need to be recomputed.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a representation of a triangle divided into four triangles by connecting the midpoints of its edges in accordance with an aspect of the present invention;

FIG. 3 is a representation of integrating over a polyhedron, in accordance with an aspect of the present invention;

FIGS. 4 and 5 comprise a flow diagram generally representing the operations for integrating over a polyhedron, in accordance with an aspect of the present invention; and

FIG. 6 is a block diagram generally representing an example graphics processing architecture into which the present invention may be incorporated.

### DETAILED DESCRIPTION

Exemplary Operating Environment

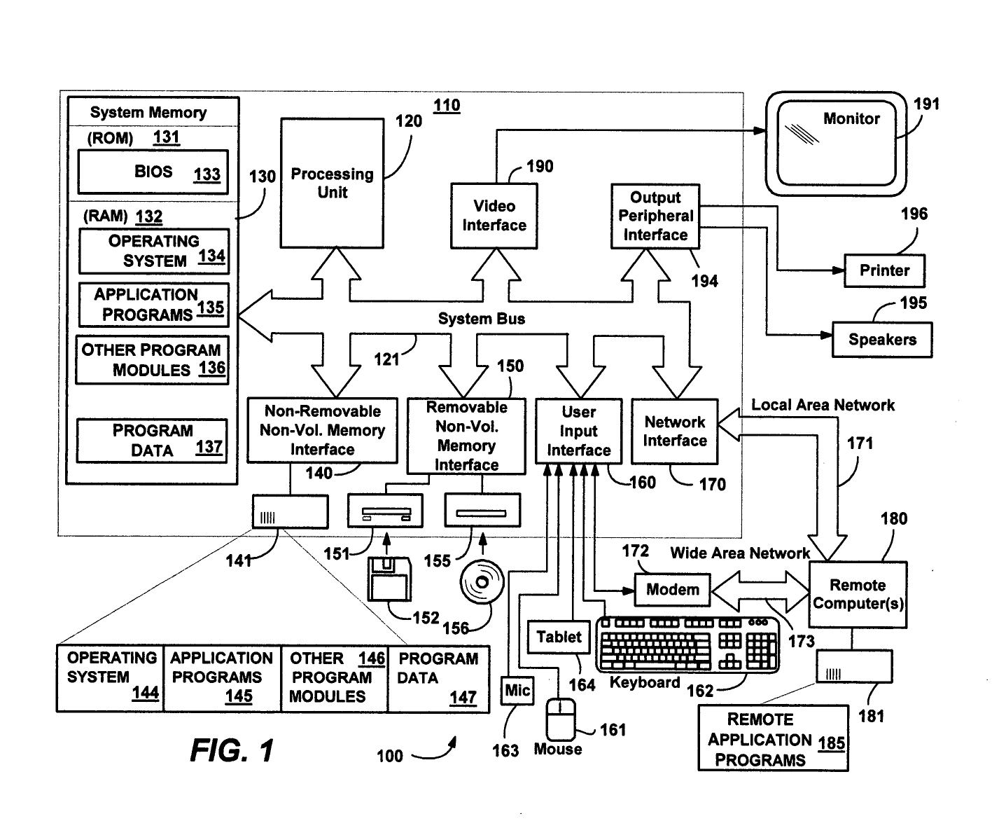

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Computing the Mass Properties of Polygons and Polyhedra

The present invention is generally directed towards a method and system for expressing integrals of quadratic homogeneous polynomials (where (ƒ(tX)=t²ƒ(X)) on polygons and polyhedra in terms of vertex coordinates. For example, the entries of the moment of inertia tensor are integrals of quadratic homogeneous polynomials, and thus the present invention is particularly beneficial in determining and expressing the entries of the moment of inertia tensor in terms of simple vertex coordinates. As can be readily appreciated, expressing complex mathematical formulae in the form of simple vertex coordinates facilitates efficient processing in many environments, such as computer graphics simulation in which many computations may have to be done within a relative short time frame. Notwithstanding, the present invention is not limited to computing the moment of inertia, nor to computer graphics processing, but rather provides many benefits in contemporary computing.

The center of mass and the moment of inertia tensor are known as the mass properties of a rigid body. The center of mass of B is

$$C = \frac{1}{m} {\int \int \int }_{B} X ρ ⅆ ν ,$$

where ρ is density and ν is volume; this is a vector notation, and X stands for (x,y,z). The moment of inertia of B about an axis is the integral

$${\int \int \int }_{B} ρ {r}^{2} ⅆ ν ,$$

where r is distance from the axis. Writing dm for ρdν, the entries of the moment of inertia tensor are:

$$\begin{matrix}{I}_{xx} = {\int \int \int }_{B} {y}^{2} + {z}^{2} ⅆ m , & {I}_{xy} = - {\int \int \int }_{B} xy ⅆ m , & {I}_{xz} = - {\int \int \int }_{B} xz ⅆ m , \\ {I}_{yx} = {I}_{xy} , & {I}_{yy} = {\int \int \int }_{B} {z}^{2} + {x}^{2} ⅆ m , & {I}_{yz} = - {\int \int \int }_{B} yz ⅆ m , \\ {I}_{zx} = {I}_{xz} & {I}_{zy} = {I}_{yz} , & {I}_{zz} = {\int \int \int }_{B} {x}^{2} + {y}^{2} ⅆ m .\end{matrix}$$

When the body B is of uniform density, the density (ρ) is a constant that may be factored out, and the remaining integrals are purely geometric properties of B. The center of mass is then called the centroid of B, which is

$$C = \frac{1}{ν} {\int }_{B} X ⅆ ν .$$

For the other properties, the density is assumed to be 1 (ρ=1) for computing the integrals. When B is a polyhedron or a planar polygon, closed formulae for these integrals are derived, in accordance with an aspect of the present invention.

A planar polygonal plate B is a body that is cut out of a planar plate of thickness t in the shape of some region R. If t is sufficiently small, then the integrand changes very little (or not at all in some cases) along a direction perpendicular to the plate, and then the volume integral

$${\int \int \int }_{B} f ( X ) ⅆ v$$

is approximated by the area integral

$$t {\int \int }_{R} f ( X ) ⅆ a .$$

In accordance with the present invention, a more geometric approach is provided in which the formulae for polygons are derived with elementary geometry, and slab integration is used to obtain the integral on a polyhedron. Note that a general framework for computing the integral of any homogeneous quadratic polynomial over polygons and polyhedra is presented herein, employing the concept of polar forms, wherein a polar form for such a polynomial ƒ(X) is a bilinear symmetric function of two (vector) variables g(X₁,X₂) for which g(X,X)=ƒ(X). The resulting formulae for the mass properties of triangles and polygons are more concise than those of those of the prior art, and thus are easier to implement, less error prone, and likely to lead to faster and/or more accurate algorithms.

As used herein, O stands for the origin. For a body B, a real number t and a point P, tB denotes the point-set {tX:XεB}, and B+P denotes the set {X+P:XεB}. The “polygon(P₁,Pₙ)” stands for a polygon having vertices P₁,Pₙ, with the convention P₀=Pₙ. Similarly, “the axis (P,V)” represents an axis through the point P that points in the direction of the unit vector V. A facet is a simple polygon with a consistently oriented sequence of vertices P_{i,1}, . . . ,P_{i,m(i)}, with the convention P_{i,0}=P_{i,m(i)}. Each facet Fᵢ is assumed to possess a well-defined, out-pointing normal unit vector Nᵢ. The vertices are assumed to be oriented clockwise when looking in the direction of Nᵢ (i.e., from the interior of B).

In one implementation, the entries of the moment of inertia tensor and the moment of inertia of a body about a given axis through the origin are volume integrals of homogeneous quadratic polynomials. As described above, the polar form for such a polynomial ƒ(X) is a bilinear symmetric function of two (vector) variables g(X₁,X₂) for which g(X,X)=ƒ(X). Although not necessary to the present invention, the existence and uniqueness of a polar form has been proved, and g can be referred to as the polar form of ƒ. The linearity and symmetry of g imply the following formula:
ƒ(P±Q)=ƒ(P)+ƒ(Q)±2g(P,Q). (1)

The following is a well known generalization of the so called Parallel Axis Theorem:

Lemma: If Cis the centroid of B, then:

$${\int \int \int }_{B} f ( X ) ⅆ v = {\int \int \int }_{B} f ( X - C ) ⅆ v + v ( B ) f ( C ) . \qquad ( 2 )$$

The planar version of formula (2) is another well known formula:

$${\int \int }_{B} f ( X ) ⅆ a = {\int \int }_{B} f ( X - C ) ⅆ a + a ( B ) f ( C ) , \qquad ( 2 a )$$

where a(B) is the area of B.

For a triangle, the centroid of a triangle T with vertices Pᵢ is simply

$$\frac{1}{3} {\sum }_{i = 1}^{3} {P}_{i} .$$

As described below, the triangle also has relatively straightforward formulae for its mass properties.

More particularly, consider the following theorem in which ƒ is a homogeneous quadratic polynomial, and g is its polar form. If T is a triangle with vertices P₁,P₂,P₃ then the following two formulae apply:

$$\begin{matrix}{\int \int }_{T} f ( X - C ) = \frac{a ( T )}{18} {\sum }_{i = 1}^{3} ( f ( {P}_{i} ) - g ( {P}_{i - 1} , {P}_{i} ) ) , & ( 3 ) \\ and & \\ {\int \int }_{T} f ( X - C ) = \frac{a ( T )}{12} {\sum }_{i = 1}^{3} f ( {P}_{i} - C ) , & ( 4 )\end{matrix}$$

where a(T) is the area of T, and C is the centroid of T.

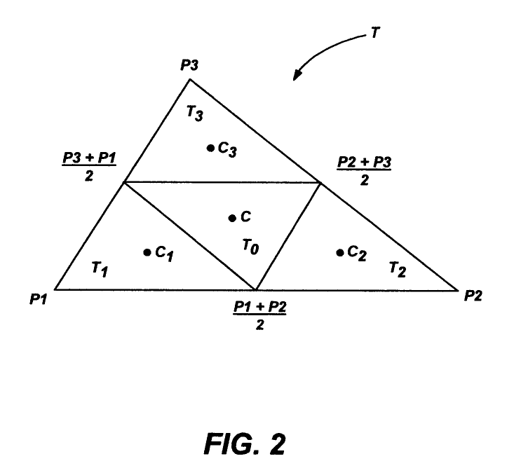

Proof: As represented in FIG. 2, T may be divided into four triangles T₀,T₁,T₂,T₃ by connecting the midpoints of its edges, giving four similar triangles, but having half-length edges. An integral over the large triangle would be the same as four times an integral over the small triangle, plus a term for the origin shift for each. Since

$$T = {⋃}_{i = 0}^{3} {T}_{i}$$

and the interiors of Tᵢ are disjoint, then it follows that:

$${\int \int }_{T} f ( X - C ) ⅆ a = {\sum }_{i = 0}^{3} {\int \int }_{{T}_{i}} f ( X - C ) ⅆ a ,$$

and by formula (2) above, that:

$${\int \int }_{T} f ( X - C ) ⅆ a = {\sum }_{i = 0}^{3} {\int \int }_{{T}_{i}} f ( X - {C}_{i} ) ⅆ a + a ( {T}_{i} ) f ( {C}_{i} - C ) ,$$

where Cᵢ is the centroid of Tᵢ. However, these sub-triangles are half-size copies of T with respect to their sides, hence

$$a ( {T}_{i} ) = \frac{1}{4} a ( T ) .$$

Moreover, as an area integral of a quadratic homogeneous polynomial,

$${\int }_{{T}_{i}}^{} \int f ( X - {C}_{i} ) ⅆ a = \frac{1}{16} {\int }_{T}^{} \int f ( X - C ) ⅆ a .$$

This is true for i=1,2,3, where Tᵢ s a straight copy of

$$\frac{1}{2} T .$$

It is somewhat not as apparent for T₀, which is a copy of

$$- \frac{1}{2} T ,$$

but it is true since ƒ is a quadratic homogeneous polynomial, hence ƒ(−X)=ƒ(X). Thus

$${\int }_{T}^{} \int f ( X - C ) ⅆ a = \frac{1}{4} {\int }_{{T}_{i}}^{} \int f ( X - C ) ⅆ a + \frac{1}{4} a ( T ) {\sum }_{i = 0}^{3} f ( {C}_{i} - C ) .$$

This is an equation in

$${\int }_{T}^{} \int f ( X - C ) ⅆ a$$

whose solution is:

$${\int }_{T}^{} \int f ( X - C ) ⅆ a = \frac{1}{3} a ( T ) {\sum }_{i = 0}^{3} f ( {C}_{i} - C ) .$$

Because C₀−C=0, ƒ(C₀−C)=0. For i=1,2,3:

$${C}_{i} = \frac{1}{3} ( {P}_{i} + \frac{1}{2} ( {P}_{i - 1} + {P}_{i} ) + \frac{1}{2} ( {P}_{i} + {P}_{i + 1} ) ) = \frac{1}{6} ( 4 {P}_{i} + {P}_{i - 1} + {P}_{i + 1} ) .$$

Further,

$$\begin{matrix}{C}_{i} - C = \frac{1}{6} ( 4 {P}_{i} + {P}_{i - 1} + {P}_{i + 1} ) - \frac{1}{3} ( {P}_{i} + {P}_{i - 1} + {P}_{i + 1} ) \\ = \frac{1}{6} ( 2 {P}_{i} - {P}_{i - 1} - {P}_{i + 1} ) .\end{matrix}$$

hence

$$f ( {C}_{i} - C ) = \frac{1}{36} f ( 2 {P}_{i} - {P}_{i - 1} - {P}_{i + 1} ) .$$

Applying formula (1) and summing up, leaves:

$$\begin{matrix}{\sum }_{i = 0}^{3} f ( {C}_{i} - C ) = \frac{1}{36} {\sum }_{i = 1}^{3} ( 6 f ( {P}_{i} ) - 6 g ( {P}_{i - 1} , {P}_{i} ) ) \\ = \frac{1}{6} {\sum }_{i = 1}^{3} ( f ( {P}_{i} ) - g ( {P}_{i - 1} , {P}_{i} ) ) ,\end{matrix}$$

which proves formula (3). Moreover

$$\begin{matrix}{C}_{i} = \frac{1}{6} ( 3 {P}_{i} + ( {P}_{i} + {P}_{i - 1} + {P}_{i + 1} ) ) = \frac{1}{6} ( 3 {P}_{i} + 3 C ) = \frac{1}{2} ( {P}_{i} + C ) , \\ hence \\ f ( {C}_{i} - C ) = f ( \frac{1}{2} ( {P}_{i} + C ) - C ) = \frac{1}{4} f ( {P}_{i} - C ) ,\end{matrix}$$

which proves formula (4).

Given these formulae, it is seen that the moment of inertia (or like quadratic homogeneous polynomials) can be determined without integration. For example, with a triangle of vertices P₁,P₂,P₃ with an origin at its center, the moment of inertia is

$$\frac{area}{12} ( {P}_{1} \cdot {P}_{2} + {P}_{2} \cdot {P}_{3} + {P}_{3} \cdot {P}_{1} ) .$$

Thus, simple multiplication and division (applied to the sums of the dot products of the vertices) provides the solution.

Moreover, as is known, particularly in computer graphics technology, any polygon may be divided into a sum of triangles. Thus, the above present invention may be applied to any polygon, including one with holes.

As another theorem, let ƒ be a homogeneous quadratic polynomial and let g be its polar form. If T is a triangle with vertices P₁,P₂,P₃ then:

$${\int \int }_{T} f ( X ) = \frac{a ( T )}{6} {\sum }_{i = 1}^{3} ( f ( {P}_{i} ) + g ( {P}_{i - 1} , {P}_{i} ) ) , \qquad ( 5 )$$

where a(T) is the area of T.

Proof: Combining formula (2) and formula (3) results in:

$${\int \int }_{T} f ( X ) ⅆ a = {\int \int }_{T} ⅆ f ( X - C ) ⅆ a + a ( T ) f ( C ) = \frac{1}{4} a ( T ) {\sum }_{i = 1}^{3} F ( {P}_{i} ) - g ( {P}_{i - 1} , {P}_{i} ) + \frac{1}{9} a ( T ) f ( {\sum }_{i = 1}^{3} {P}_{i} ) = \frac{1}{18} a ( T ) ( {\sum }_{i = 1}^{3} f ( {P}_{i} ) - g ( {P}_{i - 1} , {P}_{i} ) + 2 {\sum }_{i = 1}^{3} ( f ( {P}_{i} ) + 2 g ( {P}_{i - 1} , {P}_{i} ) ) ) = \frac{1}{6} a ( T ) {\sum }_{i = 1}^{3} ( ( {P}_{i} ) + g ( {P}_{i - 1} , {P}_{i} ) ) .$$

Turning to a consideration of integrating over a polygon, another theorem states: Let B be a planar region in the (x,y) plane bounded by a simple counterclockwise polygon (P₁, . . . ,Pₙ). Then, for any homogeneous quadratic polynomial ƒ and its polar form g, another formula is:

$${\int \int }_{B} f ( X ) ⅆ a = \frac{1}{12} {\sum }_{i = 1}^{n} det ( {P}_{i - 1} , {P}_{i} ) ( f ( {P}_{i - 1} ) + f ( {P}_{i} ) + g ( {P}_{i - 1} , {P}_{i} ) ) . \qquad ( 6 )$$

Proof: If B is convex and it contains the origin O, then it is the disjoint union of triangles Tᵢ with vertices

Since f(O)=g(X,O)=0, it follows from formula (5) that:

$${\int \int }_{B} f ( X ) = {\sum }_{i = 1}^{n} {\int \int }_{{T}_{1}} f ( X ) = \frac{1}{6} {\sum }_{i = 1}^{n} a ( {T}_{i} ) ( f ( {P}_{i - 1} ) + f ( {P}_{i} ) + g ( {P}_{i - 1} , {P}_{i} ) ) .$$

A simple triangulation process may establish the triangles as is known in the art. However, if B is non-convex does not contain the origin, then some of these triangles may overlap, while some may spill out of B. Nevertheless, equality is preserved through the use of a signed sum of the triangles, where the sign is determined by the orientation (clockwise or counterclockwise) of the path O,Pᵢ₋₁,Pᵢ.

This overlapping and spilling out is handled in a straightforward way by replacing a (Tᵢ) with one-half of the determinant relative to an origin,

$$\frac{1}{2} det ( {P}_{i - 1} , {P}_{i} ) ,$$

which inherently handles the proper sign. Taking the sum of the signed triangles that make up any polygon provides the solution.

The same argument applies to a planar polygon in any plane if replacing O with some point in the plane. For example, suppose the body B lies in a plane perpendicular to the unit vector N, and Q is a point in that plane. Denoting \overline{X}=X−Q, the signed area of the triangle (Q,Pᵢ₋₁,Pᵢ₋₁) is

$$\frac{1}{2} det ( \overline{{P}_{i - 1}} , \overline{{P}_{i - 1}} , N ) ,$$

hence for a clockwise orientation when viewed in the direction of N:

$$\int {\int }_{B} f ( X - Q ) ⅆ a = \frac{1}{12} {\sum }_{i = 1}^{n} det ( \overline{{P}_{i - 1}} , \overline{{P}_{i}} , N ) ( f ( \overline{{P}_{i - 1}} ) + F ( \overline{{P}_{i}} ) + g ( \overline{{P}_{i - 1}} , \overline{{P}_{i}} ) ) . \qquad ( 7 )$$

In sum, it is shown that integration can be avoided regardless of the shape of the polygon. More complex shapes such as those including curves can be approximated via polygons that essentially flatten the curve.

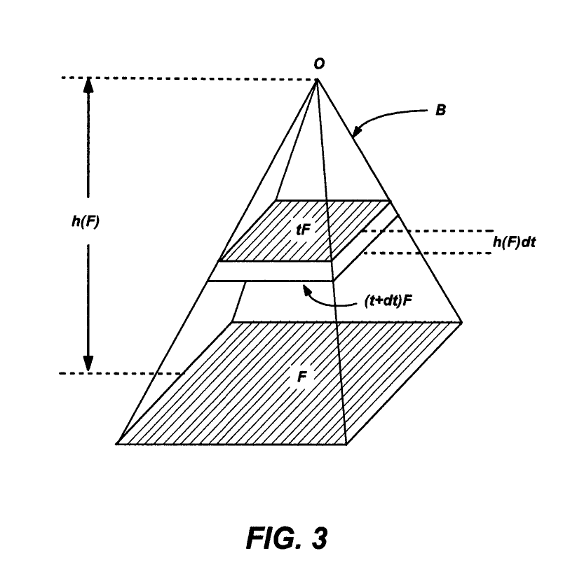

The following describes how the triangle formulae may be applied to three dimensional polyhedra via integrating over a cone. The concepts represented in FIG. 3 provide a basis for integrating over a polyhedron:

Lemma: Let B be a cone extended from the origin O to a planar (not necessarily polygonal) region F. Let h(F) be the distance from the origin to the plane of F. Then for any homogeneous quadratic polynomial ƒ:

$$\int {\int }_{B} \int f ( X ) ⅆ v = \frac{1}{5} h ( F ) {\int \int }_{F} f ( X ) ⅆ a \qquad ( 8 )$$

Proof: As represented in FIG. 3, for any positive t (such as 0≦t≦1), the body tB is a cone extended from O to tF. For a small dt, the slab between tBand (t+dt)B is a plate defined by the region tF. The distance from O to the plane of tF is h(F)t, hence the slab's thickness is h(F)dt. As an area integral of a homogeneous quadratic function,

$${\int }_{tF} \int f ( X ) ⅆ a = {t}^{4} {\int }_{F} \int f ( X ) ⅆ a .$$

B is the integral of these slabs from 0 to 1, thus:

$$\int {\int }_{B} \int f ( X ) ⅆ v = {\int }_{0}^{1} ( {\int }_{tF} \int f ( X ) ⅆ a ) h ( F ) ⅆ t \\ = h ( F ) ( {\int }_{F} \int f ( X ) ⅆ a ) {\int }_{0}^{1} {t}^{4} ⅆ t \\ = \frac{1}{5} h ( F ) {\int }_{F} \int f ( X ) ⅆ a .$$

A general polyhedron B is a “signed union” of cones extended from O to its facets Fᵢ, where the sign is determined by the side of the plane of Fᵢ that contains O, positive if O lies on the interior side. Replacing h(f) with the corresponding signed distance sh(F)=±h(f), we have for any polyhedron with facets F₁, . . . , Fₙ:

$$\int {\int }_{B} \int f ( X ) ⅆ v = \frac{1}{5} {\sum }_{i = 1}^{n} sh ( {F}_{i} ) {\int }_{{F}_{i}} \int f ( X ) ⅆ a . \qquad ( 9 )$$

An interesting special case is when B is a simplicial polyhedron, i.e. when all its facets are triangles. This is very common in computer graphics, where hardware and software are highly optimized for rendering triangles. Such a polyhedron results in the following theorem and resulting formula:

If every facet Fᵢ of B is a triangle with vertices P_{i,1},P_{i,2},P_{i,3,} and ƒ is a homogeneous quadratic polynomial then:

$$\int {\int }_{B} \int f ( X ) ⅆ v = \frac{1}{60} {\sum }_{i = 1}^{n} det ( {P}_{i , 1} , {P}_{i , 2} , {P}_{i , 3} ) {\sum }_{j = 1}^{3} ( f ( {P}_{i , j} ) + g ( {P}_{i , j - 1} , {P}_{i , j} ) ) . \qquad ( 10 )$$

Proof: Combining formulae (5) and (9) gives:

$$\int {\int }_{B} \int f ( X ) ⅆ v = \frac{1}{30} {\sum }_{i = 1}^{n} sh ( {F}_{i} ) a ( {F}_{i} ) {\sum }_{j = 1}^{3} ( f ( {P}_{i , j} ) + g ( {P}_{i , j - 1} , {P}_{i , j} ) ) .$$

However, sh(Fᵢ)a(Fᵢ) equals three times the signed volume of the cone extended from the origin to Fᵢ, and that signed volume equals

$$\frac{1}{6} det ( {P}_{i , 1} , {P}_{i , 2} , {P}_{i , 3} ) .$$

Thus,

$$sh ( {F}_{i} ) a ( {F}_{i} ) = \frac{1}{2} det ( {P}_{i , 1} , {P}_{i , 2} , {P}_{i , 3} ) ,$$

hence formula (10).

A general polyhedron may be made up of the signed sum of the cones/pyramids. Thus, for a general polyhedron, the following theorem and resulting formula applies:

Let B be a polyhedron with facets F₁,Fₙ. If ƒ is a homogeneous quadratic polynomial then:

$$\int {\int }_{B} \int f ( X ) ⅆ v = - \frac{1}{5} {\sum }_{i = 1}^{n} ( {N}_{i} \cdot {C}_{i} ) a ( {F}_{i} ) ( f ( {C}_{i} ) + \frac{1}{12} {\sum }_{j = 1}^{n} det ( \overline{{P}_{i , j - 1}} , \overline{{P}_{i , j}} , {N}_{i} ) ( f ( \overline{{P}_{i , j - 1}} ) + f ( \overline{{P}_{i , j}} ) + g ( \overline{{P}_{i , j - 1}} , \overline{{P}_{i , j}} ) ) ) \qquad ( 11 )$$

where Cᵢ is the centroid and a(Fᵢ) is the area of Fᵢ, and \overline{P_{i,j}} denotes Pᵢⱼ−Cᵢ.

Proof: Since sh(Fᵢ)=−N·Cᵢ, it follows from formulae (2) and (7) that:

$$\int {\int }_{B} \int f ( X ) ⅆ v = - \frac{1}{5} {\sum }_{i = 1}^{n} ( {N}_{i} \cdot {C}_{i} ) ( \int \int f ( X - {C}_{i} ) + a ( {F}_{i} ) f ( {C}_{i} ) ) ,$$

and formula (7) completes the proof.

Note that the centroid and area of Fᵢ can be obtained from:

$$\begin{matrix}a ( {F}_{i} ) = \frac{1}{2} {\sum }_{j = 3}^{m ( i )} det ( {P}_{i , j - 1} - {P}_{i , 1} , {P}_{i , j} - {P}_{i , 1} , {N}_{i} ) & ( 12 ) \\ {C}_{i} = \frac{1}{6 a ( {F}_{i} )} {\sum }_{j = 3}^{m ( i )} det ( {P}_{i , j - 1} - {P}_{i , 1} , {P}_{i , j} - {P}_{i , 1} , {N}_{i} ) ( {P}_{i , 1} + {P}_{i , j - 1} + {P}_{i , 1} ) . & ( 13 )\end{matrix}$$

Any mass properties formula can now be generated by defining the appropriate function ƒ and multiplying by density. For example, with ƒ(X)=X·X, and its polar form g(X₁,X_{2)=X}₁·X₂ we have from formula (4) that the moment of inertia of a triangle with vertices P₁,P₂,P₃, mass m and centroid C, about an axis perpendicular to the plane of T at C is:

$$\begin{matrix}\frac{m}{12} {\sum }_{i = 1}^{3} ( {P}_{i} - C ) \cdot ( {P}_{i} - C ) , \\ or : \\ \frac{m}{18} {\sum }_{i = 1}^{3} ( {P}_{i} \cdot {P}_{i} - {P}_{i - 1} \cdot {P}_{i} ) .\end{matrix}$$

The squared distance of a point X from the axis (O,V) is (X×V)·(X×V). This is a quadratic homogeneous function, whose polar form is (X₁×V)·(X₂×V). In keeping with the present invention, it follows from formula (5) that the moment of inertia of a triangle with vertices P₁,P₂,P₃ and mass m about an axis (O,V) is:

$$\frac{1}{6} m {\sum }_{i = 1}^{3} ( ( {P}_{i} \times V ) \cdot ( {P}_{i} \times V ) + ( {P}_{i - 1} \times V ) \cdot ( {P}_{i} \times V ) ) .$$

Similarly, with the same squared distance function, multiplying formula (7) by (mass/area) density produces a formula for the moment of inertia of a polygonal plate about an axis (Q,V), where Q is any point in the polygon's plane. Note that formula (5) produces the moment of inertia of a triangle about any axis through the origin, and the origin can be shifted to any point with a simple transformation. In contrast, the polygon formula will not work for an axis that does not intersect the polygon's plane.

Again, with the same squared distance function, multiplying formula (10) and formula (11) by (volume/area) density produces formulae for the moment of inertia of a polyhedron about an axis (O,V) through the origin.

The integrands for the entries of moment of inertia tensor are:
For Iₓₓ: ƒ(X)=y²+z² and the polar form is g(X₁,X₂)=y₁y₂+z₁z₂.
For I_{yy}: ƒ(X)=z²+x² and the polar form is g(X₁,X₂)=z₁z₂+x₁x₂.
For I_{zz}: ƒ(X)=x²+y² and the polar form is g(X₁,X₂)=x₁x₂+y₁y₂.

$$\begin{matrix}For {I}_{xy} : f ( X ) = - xy and the polar form is g ( {X}_{1} , {X}_{2} ) = - \frac{1}{2} ( {x}_{1} {y}_{2} + {y}_{1} {x}_{2} ) . \\ For {I}_{yz} : f ( X ) = - yz and the polar form is g ( {X}_{1} , {X}_{2} ) = - \frac{1}{2} ( {y}_{1} {z}_{2} + {z}_{1} {y}_{2} ) . \\ For {I}_{zx} : f ( X ) = - zx and the polar form is g ( {X}_{1} , {X}_{2} ) = - \frac{1}{2} ( {z}_{1} {x}_{2} + {x}_{1} {z}_{2} ) .\end{matrix}$$

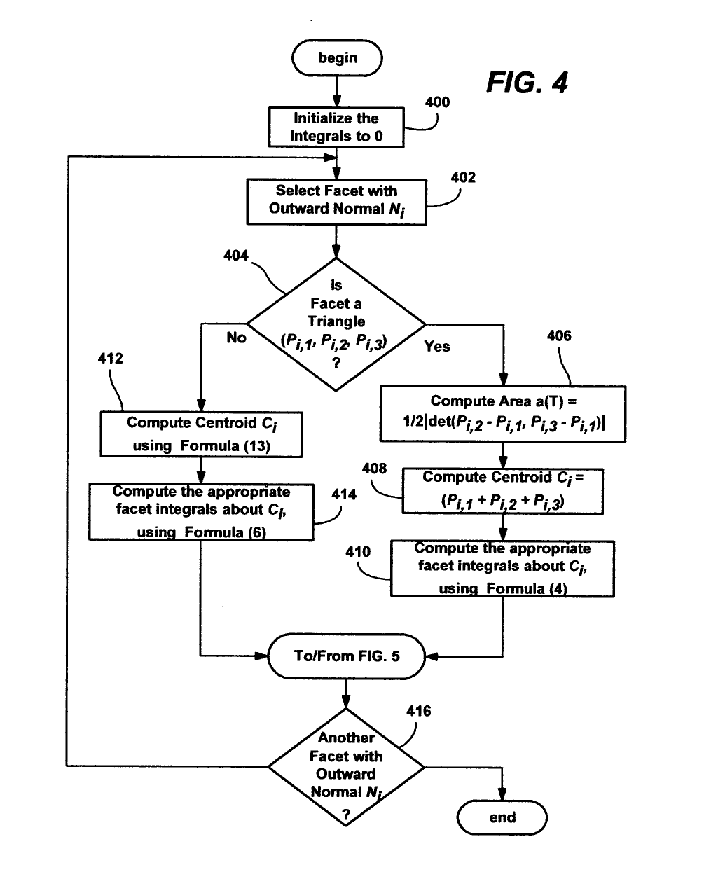

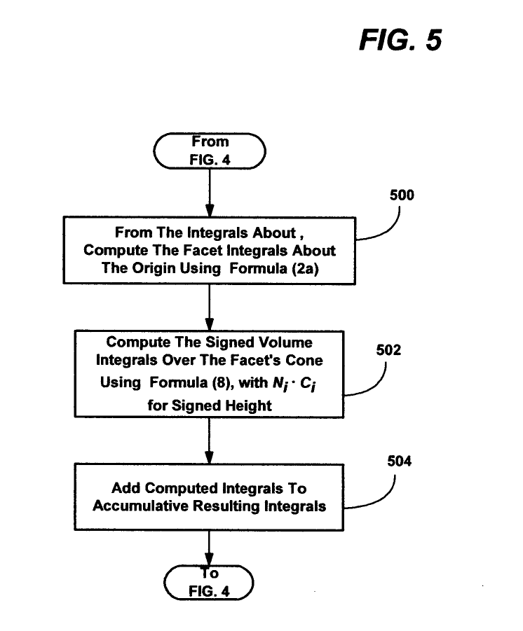

Turning to an explanation of the present invention with reference to the flow diagrams of FIGS. 4 and 5, the present invention can selectively combine the formulae to produce a desired results without integration, based on the likelihood that the most concise formula does not necessarily make the most efficient or most accurate algorithm. By way of example, the following algorithm for integrating over a polyhedron is likely more efficient than any straight application of formulae (10) or (11), described above.

As represented in FIG. 4, at step 400 the integrals are initialized to zero. Then via step 402 (and later step 416 which loops back to handle each facet), for each facet with outward normal Nᵢ, if at step 404 the facet is a triangle (P_{i,1},P_{i,2},P_{i,3}), the process branches to step 406.

Step 406 computes the area of the triangle from the vertices, using the above described formula a(T)=

$$\frac{1}{2} \vert det ( {P}_{1 , 2} - {P}_{i , 1} , {P}_{i , 3} - {P}_{i , 1} ) \vert .$$

Step 408 computes the centroid,

$${C}_{i} = \frac{1}{3} ( {P}_{i , 1} + {P}_{i , 2} + {P}_{i , 3} ) .$$

With the centroid and area known, and applied to formula (4) described above, namely

$$\int {\int }_{T} f ( X - C ) = \frac{a ( T )}{12} {\sum }_{i = 1}^{3} f ( {P}_{i} - C ) ,$$

the appropriate facet integrals about centroid Cᵢ, using this formula are easily computed, as represented by step 410.

Returning to step 404, if the facet is not a triangle, step 412 is instead executed, and computes the centroid of the facet using formula (13) described above, namely, the centroid of the facet,

$${C}_{i} = \frac{1}{6 a ( {F}_{i} )} {\sum }_{j = 3}^{m ( i )} det ( {P}_{i , j - 1} - {P}_{i , 1} , {P}_{i , j} - {P}_{i , 1} , {N}_{i} ) ( {P}_{i , 1} + {P}_{i , j - 1} + {P}_{i , 1} ) .$$

Then, at step 414, the appropriate facet integrals about Cᵢ are computed using formula (6) described above, namely:

$${\int \int }_{B} f ( X ) ⅆ a = \frac{1}{12} {\sum }_{i = 1}^{n} det ( {P}_{i - 1} , {P}_{i} ) ( f ( {P}_{i - 1} ) + f ( {P}_{i} ) + g ( {P}_{i - 1} , {P}_{i} ) ) .$$

With the integrals about the centroid of the facet Cᵢ, whether computed for a triangle or otherwise, the process continues to FIG. 5, to compute at step 500 the facet integrals about the origin using formula (2a) described above, that is:

$$\int {\int }_{B} f ( X ) ⅆ a = \int {\int }_{B} f ( X - C ) ⅆ a + a ( B ) f ( C ) .$$

Step 502 computes the signed volume integrals over the facet's cone using formula (8),

$$\int {\int }_{B} \int f ( X ) ⅆ v = \frac{1}{5} h ( F ) \int {\int }_{F} f ( X ) ⅆ a ,$$

with Nᵢ·Cᵢ for the signed height. Step 506 adds the computed integrals to the accumulative resulting integrals, before returning to step 416 of FIG. 4.

As described above, step 416 of FIG. 4 returns to step 402 to select the next facet with an outward normal Nᵢ, until none remain, at which time the accumulative resulting integrals are known. It should be noted that shifting the polyhedron closer to the origin before executing the process of FIGS. 4 and 5 may further enhance accuracy. This is because when dealing with large numbers, truncation, other approximations and so forth are more likely to occur than when dealing with smaller numbers, so choosing a point as the origin, such as the center of mass, that will keep the numbers smaller, will likely be more accurate.

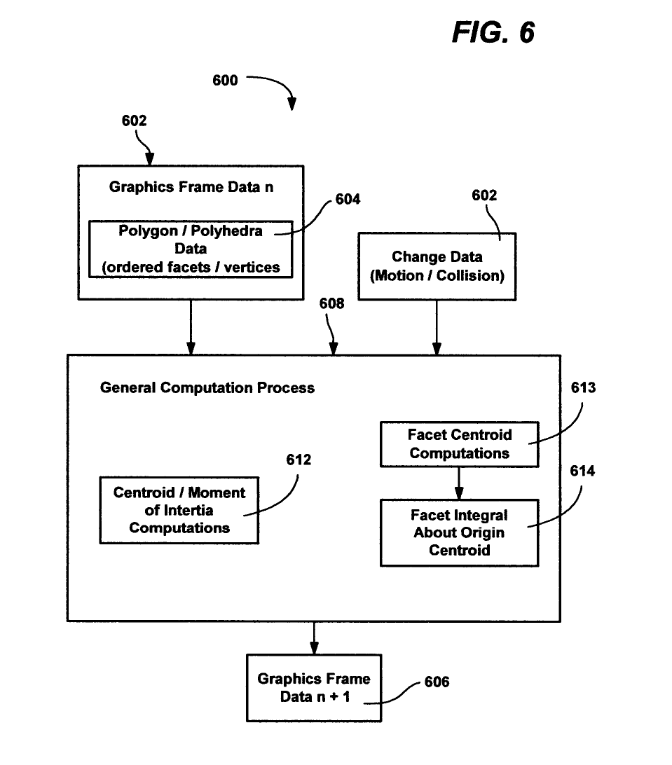

FIG. 6 provides an example architecture 600 in which the present invention, such as the incorporating the algorithm of FIGS. 4 and 5, may be implemented. In FIG. 6, the data 602 needed to render a graphics frame n, which may include polygon/polyhedra data such as in the form of ordered facets and/or vertices 604 may be used to calculate a subsequent frame 606. For example, a general computation process 608 may copy the graphics frame 602 and modify it for the subsequent frame 606 based on change data 610. To adjust the motion of objects to compensate for collisions or other forces 602, the general computation process 608 may include (or otherwise communicate with) the algorithm of FIGS. 4 and 5, primarily represented by separate components 612-614 in FIG. 6. In general, in basic animation the centroid and moment of inertia is computed only once for a rigid body, and thus would not normally be recomputed for each frame.

Note that contemporary computer graphics use large quantities of triangles, and thus the present invention can provide substantial benefits when the mass properties of an object or multiple objects need to be recomputed. For example, the moments of inertia for many smaller objects following the breakup of a larger object could be likewise computed rapidly for use in subsequent frames using the present invention. As another example, an image of an ice skater spinning faster by moving in his or her arms (which changes the moment of inertia) could be rapidly calculated for each frame to provide more realistic rendering.

As can be seen from the foregoing detailed description, there is provided a method and system to compute the mass properties of polygons and polyhedra, including by which the moment of inertia of polygons and polyhedra may be efficiently and accurately determined. The method and system also extend to any quadratic homogeneous polynomial. The present invention may be used as a convenient and straightforward mechanism for determining mass properties for graphics processing, as well as in other technical applications, and thus provide significant advantages and benefits needed in contemporary computing.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

1. In a computing environment, a method comprising:
for a homogeneous quadratic polynomial, determining properties, including
a) determining the centroid of a triangle from vertices of the triangle; and
b) solving an area integral for the triangle without integration based on based on an area of the triangle and the vertices; and
providing the properties to a computer component for subsequent processing.

2. The method of claim 1 wherein solving the area integral for the triangle (T) without integration and with vertices P₁,P₂,P₃ uses the formula
$$\frac{a ( T )}{12} {\sum }_{i = 1}^{3} f ( {P}_{i} - C )$$
where a(T) is the area and C is the centroid of T.

3. The method of claim 1 wherein solving the area integral for the triangle comprises determining the area of the triangle from one-half a determinant based on the vertices.

4. The method of claim 1 wherein the properties correspond to the mass properties of a body and the area integral for the triangle corresponds to the moment of inertia of the triangle, and wherein providing the mass properties to the computer component for subsequent processing comprises determining the moment of inertia for a graphics processing component.

5. The method of claim 1 further comprising, determining another centroid of another triangle from vertices of the other triangle, solving another area integral for the other triangle without integration based on based on an area of the other triangle and the vertices, and summing results of each triangle to provide the properties of a polygon constructed from at least the triangle and the other triangle.

6. The method of claim 1 further comprising, solving a volume integral for a simplicial polyhedron having facets comprising triangles without integration by using the area integral.

7. A computer-readable medium having computer-executable instructions for performing the method of claim 1.

8. In a computing environment, a method comprising:
determining a moment of inertia of a triangular body about an axis perpendicular to a plane of the triangular body from a mass value and vertices of the triangular body; and
providing the moment of inertia to a computer component for subsequent processing.

9. The method of claim 8 wherein determining the moment of inertia comprises applying the formula:
$$\frac{m}{18} {\sum }_{i = 1}^{3} ( {P}_{i} \cdot {P}_{i} - {P}_{i - 1} \cdot {P}_{i} )$$
where m is the mass value and Pᵢ and Pᵢ₋₁ are vertices.

10. The method of claim 8 wherein determining the moment of inertia comprises applying the formula:
$$\frac{m}{12} {\sum }_{i = 1}^{3} ( {P}_{i} - C ) \cdot ( {P}_{i} - C )$$
where m is the mass value, c is a centroid of the triangular body, and Pᵢ and Pᵢ₋₁ are vertices.

11. The method of claim 10 further comprising, determining the centroid from the vertices.

12. A computer-readable medium having computer-executable instructions for performing the method of claim 8.

13. In a computing environment, a method comprising:
(a) selecting a facet of polyhedron as a selected facet, the selected facet comprising a triangle;
(b) computing a centroid of the facet;
(c) computing an area of the facet;
(d) computing facet integrals about the centroid;
(e) computing facet integrals about the origin from the integrals about the centroid;
(f) computing volume integrals over a facet cone;
(g) adding the computed volume integrals to resulting integrals;
(h) selecting a facet that was not previously selected as the selected facet and returning to step (b) until each facet has been selected; and
(i) providing the resulting integrals to a computer component for subsequent processing.

14. A computer-readable medium having computer-executable instructions for performing the method of claim 13.

15. In a computing environment, a method comprising:
(a) selecting a facet of polyhedron as a selected facet;
(b) determining whether the selected facet is a triangle, and when the selected facet is a triangle,
(i) computing an area of the facet;
(ii) computing facet integrals about the centroid;
(iii) computing facet integrals about the origin from the integrals about the centroid;
and when the selected facet is not a triangle,
(iv) computing facet integrals about the centroid;
(v) computing facet integrals about the origin;
(c) computing volume integrals over a facet cone;
(d) adding the computed volume integrals to resulting integrals;
(e) selecting a facet that was not previously selected as the selected facet and returning to step (b) until each facet has been selected; and
(f) providing the resulting integrals to a computer component for subsequent processing.

16. A computer-readable medium having computer-executable instructions for performing the method of claim 15.
